(19) United States
(12) Patent Application Publication
(10) Pub. No.: US 2013/0025334 A1
(43) Pub. Date: Jan. 31, 2013

(54) Theft Deterrent for Backflow Preventers

(71) Applicants: Robert Scott Vann, Spring, TX (US); Thomas Lee Medley, Spring, TX (US)

(72) Inventors: Robert Scott Vann, Spring, TX (US); Thomas Lee Medley, Spring, TX (US)

(21) Appl. No.: 13/190,227

(22) Filed: Jul. 25, 2011

(51) Int. Cl. E05B 73/00

(52) U.S. Cl. 70/58

(57) ABSTRACT

Embodiments of the disclosed inventive subject matter may include a securing member for a theft deterrent device for a backflow preventer, a theft deterrent device for a backflow preventer, a theft deterrent system for a backflow preventer, and a method for deterring theft of a backflow preventer. Embodiments of the securing member may include channels having securing sections therein. Embodiments of the theft deterrent device may include a mating member positioned next to the securing member. Embodiments of the system may include engagement devices positioned in the channels of the mating and securing members, wherein engagement mechanisms of the engagement devices engage the securing sections. The method may include positioning the theft deterrent device around a backflow preventer, inserting the engagement devices into the theft deterrent device, engaging the engagement mechanisms, connecting the theft deterrent device to a post, and anchoring the post.

### BACKGROUND

Embodiments of the inventive subject matter generally relate to backflow preventers. Particularly, embodiments of the inventive subject matter relate to theft deterrents for backflow preventers.

Backflow preventers are used to control the flow of water in water supply systems for neighborhoods, businesses, irrigation systems for landscapes and other end users. Water supply systems are typically connected to the public water supply lines, and backflow preventers prevent water in the water supply systems from flowing back into the public water supply lines, which can occur when pipes freeze, during significant drops in supply pressure or a water main breaks. The prevention of water backflow into the public water supply lines prevents contamination of the public water supply and promotes health and safety of the public.

Backflow preventers include pressure vacuum breakers, double check valves, atmospheric pressure breakers, and reduced pressure zone devices, among others. These devices are substantially made of valuable metals—for example, pressure vacuum breakers are made substantially of copper or brass. Backflow preventers are typically connected by pipes to the water supply system on one end and to the public water supply on the other end. Moreover, backflow preventers can be positioned above ground for easy access and maintenance. For example, pressure vacuum breakers are typically positioned above the highest point in a water supply system due to operation requirements of pressure vacuum breakers.

A recent trend involving backflow preventers is their theft from water supply systems, and particularly theft of pressure vacuum breakers from exposed irrigation systems. Thieves cut the pipes connected to the pressure vacuum breaker in a matter of seconds. To address this problem, security enclosures and cages can be used to protect the backflow preventers from theft. The security enclosures can entirely enclose the backflow preventer and typically have locks or other security means to access the backflow preventer contained therein. For large water supply systems, such as a large irrigation system for a golf resort, maintenance personnel could need scores of keys or other means to open the security enclosures in order to access the backflow preventers. Moreover, laws and regulations requiring inspection of backflow preventers require inspectors to make appointments or to request use of the keys or other means needed to open the security enclosure to inspect the backflow preventers, resulting in a huge loss of inspection efficiency and personnel hours in coordinating activities not related to the security or inspection of the backflow preventers. Moreover still, purchase and installation of security enclosures can cost upwards of $1,000 per enclosure, resulting in a huge capital expense for water supply systems having tens and hundreds of backflow preventers. Moreover still, huge amounts of drinkable water can be wasted after a backflow preventer freezes or otherwise fails because access to security enclosures can depend on the availability of personnel and locating the correct key.

Other security devices are available to help deter theft of backflow preventers which do not have the inaccessibility problems associated with security enclosures; however, these security devices have not proven to adequately deter theft.

### SUMMARY OF THE INVENTION

Embodiments of the disclosed inventive subject matter may include a securing member for a theft deterrent device for a backflow preventer, a theft deterrent device for a backflow preventer, a theft deterrent system for a backflow preventer, and a method for deterring theft of a backflow preventer.

Embodiments of a securing member for a theft deterrent device for a backflow preventer may include a first portion, a second portion extending from an end of the first portion, and a third portion extending from an opposite end of the first portion. The second portion of the securing member may have a channel extending therein, and the third portion of the securing member may have a channel extending therein. The channel of the second portion and the channel of the third portion each may have a securing section therein.

Embodiments of a theft deterrent device for a backflow preventer may include the securing member, and a mating member. The mating member may include a first portion, a second portion extending from an end of the first portion of the mating member, and a third portion extending from an opposite end of the first portion of the mating member. The second portion of the mating member may have a channel extending therethrough, and the third portion of the mating member may have a channel extending therethrough. The channel of the second portion of the mating member may be aligned with the channel of the third portion of the securing member, and the channel of the third portion of the mating member may be aligned with the channel of the second portion of the securing member. The mating member may have a length greater than a length of the securing member. The channel of the second portion of the securing member and the channel of the third portion of the securing member each may have an alignment section, and the securing section may have a length substantially greater than a length of the alignment section. The mating member and the securing member each may have a concavity, and the concavity of the mating member may face the concavity of the securing member. The concavity of the mating member and the concavity of the securing member may form a substantially rectangular shape when the mating member faces the securing member.

Embodiments of the theft deterrent system for a backflow preventer may include the theft deterrent device, a first engagement device positioned through the channel of the third portion of the mating member and in the channel of the second portion of the securing member, a second engagement device positioned through the channel of the second portion of the mating member and in the channel of the third portion of the securing member, a post connected to the mating member of the theft deterrent device, and an anchor fixed to the post. The first engagement device may have an engagement mechanism positioned in the securing section of the second portion of the securing member, and the second engagement device may have an engagement mechanism positioned in the securing section of the third portion of the securing member. The first engagement member may have a security mechanism on an end thereof, and the second engagement member may have a security mechanism on an end thereof.

Embodiments of a method for deterring theft of a backflow preventer may include positioning the theft deterrent device around the backflow preventer, inserting a first engagement device into the theft deterrent device, inserting a second engagement device into the theft deterrent device, engaging an engagement mechanism of the first engagement device with the securing section of the second portion of the securing member of the theft deterrent device, engaging an engagement mechanism of the second engagement device with the securing section of the third portion of the securing member of the theft deterrent device, positioning a post adjacent the theft deterrent device, inserting the first engagement device through the post, inserting the second engagement device through the post, and anchoring the post.

### BRIEF DESCRIPTION OF THE DRAWINGS

The present embodiments may be better understood, and numerous objects, features, and advantages made apparent to those skilled in the art by referencing the accompanying drawings.

FIG. 1 shows a perspective view of an embodiment of the theft deterrent device for backflow preventers.

FIG. 2 shows a cross-sectional view of an embodiment of the theft deterrent device for backflow preventers, taken along sight line 2-2 shown in FIG. 1.

FIG. 3 shows an elevational view of an embodiment of the theft deterrent system for backflow preventers.

FIG. 4 shows an isolated elevational view of an embodiment of theft deterrent device, engagement devices, and post of the theft deterrent system.

FIG. 5 shows an isolated elevational view of another embodiment of the theft deterrent device, engagement devices, and post of the theft deterrent system.

FIG. 6 shows a plan view of an embodiment of the theft deterrent system.

### DETAILED DESCRIPTION OF THE EMBODIMENT(S)

The description that follows includes exemplary devices, systems, methods, techniques, and tools that embody the disclosed inventive subject matter. However, it should be understood that the described embodiments may be practiced without describing certain specific details that are well known—such as well-known structures, materials, techniques, and configurations—in order not to obfuscate the description of the inventive subject matter. For instance, although the description of embodiments refers to backflow preventers, specific configurations and types of backflow preventers may not be described in detail because such configurations and types are well known.

As will be appreciated by one skilled in the art, aspects of the disclosed inventive subject matter may be embodied as a securing member, device, system, or method. Accordingly, aspects of the disclosed inventive subject matter may take the form of an entirely structural embodiment, a functional embodiment, a methodological embodiment, or an embodiment combining these various aspects of the inventive subject matter.

Embodiments of the disclosed inventive subject matter may include a securing member for a theft deterrent device for a backflow preventer, a theft deterrent device for a backflow preventer, a theft deterrent system for a backflow preventer, and a method for deterring theft of a backflow preventer.

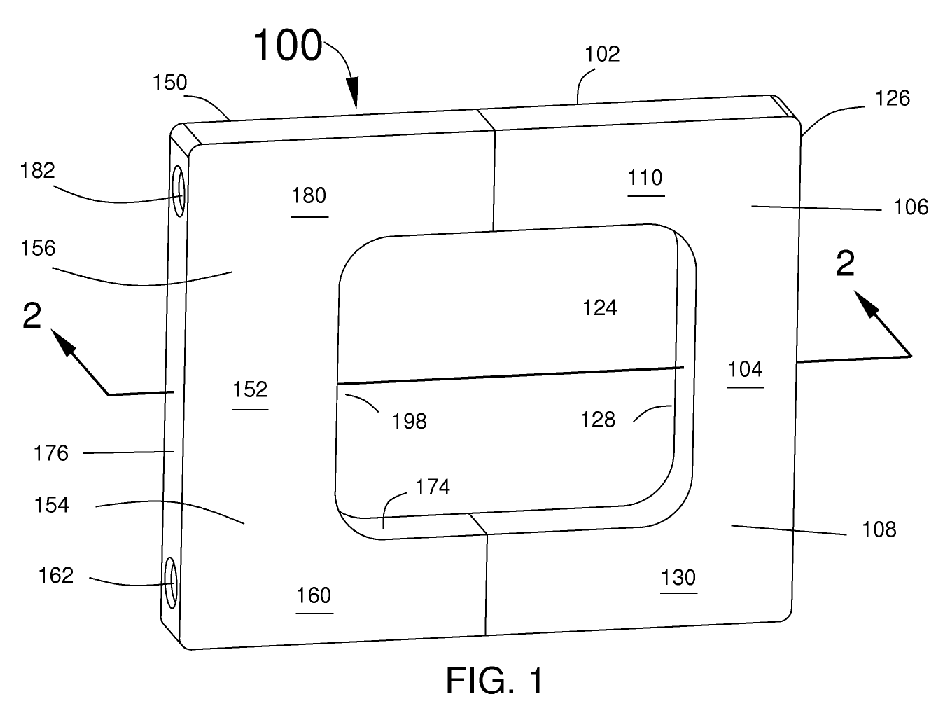

FIG. 1 shows a perspective view of an embodiment of the theft deterrent device 100 for backflow preventers. Embodiments of the theft deterrent device 100 may include a securing member 102 and a mating member 150. The securing member 102 may include a first portion 104, a second portion 110 extending from an end 106 of the first portion 104, and a third portion 130 extending from an opposite end 108 of the first portion 104. The mating member 150 may include a first portion 152, a second portion 160 extending from an end 154 of the first portion 152 of the mating member 150, and a third portion 180 extending from an opposite end 156 of the first portion 152 of the mating member 150. The second portion 160 of the mating member 150 may have a channel 162 extending therethrough, and the third portion 180 of the mating member 150 may have a channel 182 extending therethrough. The third portion 180 of the mating member 150 may have a length equal to a length of the second portion 160 of the mating member 150, and the third portion 130 of the securing member 102 may have a length equal to a length of the second portion 110 of the securing member 102. The mating member 150 and the securing member 102 of the theft deterrent device 100 each may have a concavity, and the concavity 198 of the mating member 150 may face the concavity 128 of the securing member 102. The concavity 198 of the mating member 150 and the concavity 128 of the securing member 102 may form a substantially rectangular shape when the mating member 150 faces the securing member 102. The rectangular shape gives the theft deterrent device 100 flexibility for fitting around various types and configurations of backflow preventers. Moreover, the rectangular shape of the concavities 198 and 128 unexpectedly provides more flexibility than a circular shape for the orientation of the theft deterrent device 100. It should be understood the concavities 198 and 128 of the theft deterrent device 100 may be configured to form other shapes in order to accommodate for different configurations of backflow preventers. The channel 162 of the mating member 150 and the channel 182 of the mating member 150 each may open to a side 176 of the mating member 150.

The second portion 160 and third portion 180 of the mating member 150 may extend generally perpendicular to the first portion 152 of the mating member 150. Likewise, the second portion 110 and the third portion 130 of the securing member 102 may extend generally perpendicular to the first portion 104 of the securing member 102. Moreover, the second portion 160 and third portion 180 of the mating member 150 may extend generally perpendicular to the first portion 104 of the securing member 102, and the second portion 110 and third portion 130 of the securing member 102 may extend generally perpendicular to the first portion 152 of the mating member 150. The first portions 152 and 104, second portions 110 and 160, and third portions 130 and 180 may be configured so the theft deterrent device 100 has a generally rectangular shape. Further the first portions 152 and 104, second portions 110 and 160, third portions 130 and 180, and the concavities 128 and 198 may be configured so the theft deterrent device 100 has a generally rectangular opening formed by the concavities 128 and 198.

In one or more embodiments, the theft deterrent device 100 may have a length and height greater than a thickness of the theft deterrent device 100. Generally, a thickness of the theft deterrent device 100 may be at least about ¾″. In one or more embodiments, the thickness of the theft deterrent device 100 is about ¾″, the length is about 6″, and the height is about 5″, for example. In one or more embodiments, the thickness of the theft deterrent device 100 is about 1″, the length is about 6″, and the height is about 5″, for example. The relatively small thickness of the theft deterrent device 100 may allow the device 100 to avoid obstructing parts (e.g. valve handles and petcocks) of a backflow preventer. However, the thickness of the theft deterrent device 100 may be large enough to prevent thieves from cutting quickly through the theft deterrent device 100. The thickness of the mating member 150 may be the same as the thickness of the securing member 102.

A backflow preventer may fit into the rectangular-shaped opening formed by concavities 128 and 198 when the securing member 102 and mating member 150 face one another. Because different sizes of backflow preventers exist, the rectangular-shaped opening may have different dimensions. In one or more embodiments, the rectangular-shaped opening formed by concavities 128 and 198 has a length of about 3.5″ and a height of about 3″, or a length of about 3″ and a height of about 2.5″, or a length of about 2.5″ and a height of about 2″, for example.

In one or more embodiments, the theft deterrent device 100 may be made of a material which is not easily cut, such as metal(s) or high strength polymer(s). Thus, the thickness of the theft deterrent device 100 may depend on the size of the engagement devices (discussed below) and on the strength of the material of construction.

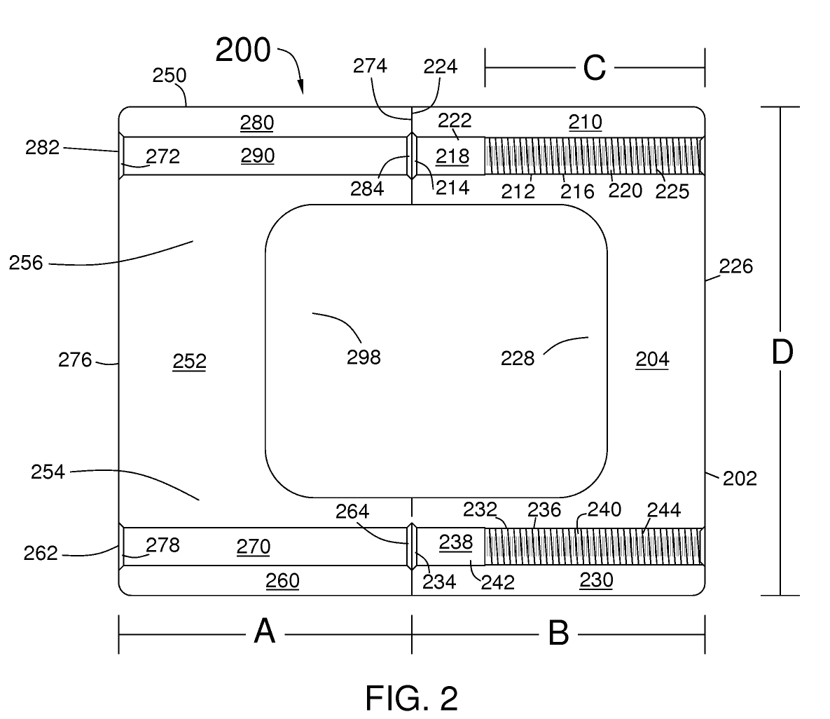

FIG. 2 shows a cross-sectional view of an embodiment of the theft deterrent device 200 for backflow preventers, taken along sight line 2-2 shown in FIG. 1. As can be seen in the embodiment, mating member 250 may have a length A that is equal to a length B of the securing member 202. In one or more embodiments, the length A of the mating member 250 is about 3″ and the length B of the securing member 202 is about 3″. The mating member 250 and the securing member 202 may have the same height D. Concavity 228 may be formed on side 224 of the securing member 202, and concavity 298 may be formed on side 274 of the mating member 250. In FIG. 2, concavities 228 and 298 each have a U-shape. When securing member 250 and mating member 202 face one another, concavities 228 and 298 form a rectangular-shaped opening. As shown in FIG. 2, the opening formed by the concavities 228 and 298 may be slightly offset from center of the theft deterrent device 200 so that concavity 228 may be larger than concavity 298. Channels 212, 232, 262, and 282 are formed inside of the theft deterrent device 200 and may extend from side 276 of the mating member 250 to the side 226 of the securing member 202.

The second portion 260 of the mating member 250 may have a channel 262 extending therethrough, and the third portion 280 of the mating member 250 may have a channel 282 extending therethrough. The channels 262 and 282 of the mating member 250 may open to side 274 and opposite side 276 of the mating member 250. Channel 262 has an inner surface 270 which is smooth, and channel 282 has an inner surface 290 which is smooth.

Lips may be formed within the mating member 250 and securing member 202 at the ends of the channels. Lips 272 and 284 may be formed at the ends of channel 282, and lips 278 and 264 may be formed at the ends of channel 262. Generally lips 272 and 278 angle inwardly from side 276 of the mating member 250 to the channels 282 and 262, respectively, and lips 284 and 264 angle inwardly from said 274 of the mating member 250 to the channels 282 and 262, respectively. The lips 272 and 278 serve to guide the engagement devices into the channels 282 and 262, respectively of the mating member 250 of the theft deterrent device 200. Although lips 264, 272, 278, and 284 are shown in FIG. 2, it should be understood embodiments of the inventive subject matter may not include lips.

The second portion 210 of the securing member 202 may have a channel 212 extending therein, and the third portion 230 of the securing member 202 may have a channel 232 extending therein. As shown in FIG. 2, the channels 212 and 232 may open to side 224 of securing member 202 and extend adjacent side 226 of the securing member 202 without opening to opposite side 226 of the securing member 226. Alternatively, the channels 212 and 232 may open to side 224 and to opposite side 226 of the securing member 202. The channel 262 of the second portion 260 of the mating member 250 may be aligned with the channel 232 of the third portion 230 of the securing member 202, and the channel 282 of the third portion 280 of the mating member 250 may be aligned with the channel 212 of the second portion 210 of the securing member 202. That is, the channel 262 of the mating member 250 and the channel 232 of the securing member 202 form a continuous channel when the side 274 of the mating member 250 faces the side 224 of the securing member 202, and the channel 282 of the mating member 250 and the channel 212 of the securing member 202 form a continuous channel when the side 274 of the mating member 250 faces the side 224 of the securing member 202. The channels 282, 262, 212, and 232 may have generally the same diameter and have a tubular shape.

Lip 214 may be formed on the end of the channel 212 adjacent side 224 of the securing member 202, and lip 234 may be formed on the end of the channel 232 adjacent side 224 of the securing member 202. Generally lips 214 and 234 angle inwardly from side 224 of the securing member 202 to the channels 212 and 232. Although lips 214 and 234 are shown in FIG. 2, it should be understood embodiments of the inventive subject matter may not include lips. Alternatively, it should be understood if the channels 212 and 232 of the securing member 202 open to opposite side 226, lips may be formed on the ends of the channels 212 and 232 adjacent side 226.

The channel 212 of the second portion 210 of the securing member 202 and the channel 232 of the third portion 230 of the securing member 202 each may have a securing section therein. The securing section 216 of the channel 212 of the second portion 210 of the securing member 202 and the securing section 236 of the channel 232 of the third portion 230 of the securing member 202 may have engagement mechanisms 225 and 244, respectively, formed in or on inner surfaces thereof. In the embodiment shown in FIG. 2, the engagement mechanism 225 is threads formed on an inner surface 220 of the securing section 216 of the second portion 210, and the engagement mechanism 244 is threads formed on an inner surface 240 of the securing section 236 of the third portion 230. Although FIG. 2 shows threads for engagement mechanisms 225 and 244 in the securing sections 216 and 236, respectively, the securing sections 216 and 236 may have other engagement mechanisms, such as a hole(s) for receiving an engagement mechanism of engagement devices (discussed below).

In one or more embodiments, the channel 212 of the second portion 210 of the securing member 202 and the channel 232 of the third portion 230 of the securing member 202 each may have an alignment section. That is, the channel 212 may have an alignment section 218, and the channel 232 may have an alignment section 238. The alignment sections 218 and 238 may allow for one-person installation of the theft deterrent device 200. The alignment section 218 may have an end adjacent side 224 of the securing member and an opposite end adjacent the securing section 216, and the securing section 216 may have an end adjacent the alignment section 218 and an opposite end adjacent the side 226 of the securing member 202. The alignment section 218 may be adjacent the securing section 216, and the alignment section 218 may be adjacent side 224 of the securing member 202 while the securing section 216 may be adjacent both sides 224 and 226 of the securing member 202. The alignment section 238 may have an end adjacent side 224 of the securing member 202 and an opposite end adjacent the securing section 236, and the securing section 236 may have an end adjacent the alignment section 238 and an opposite end adjacent the side 226 of the securing member 202. The alignment section 238 may be adjacent the securing section 236, and the alignment section 238 may be adjacent side 224 of the securing member 202 while the securing section 236 may be adjacent both sides 224 and 226 of the securing member 202.

In one or more embodiments, the length C of the securing sections 216 and 236 is about 2.25″, and the threads may be about ⅜″-16 threads, for example. The securing section 216 may have a length substantially greater than a length of the alignment section 218. The securing section 236 may have a length substantially greater than a length of the alignment section 238. The alignment sections 218 and 238 may serve to guide engagement devices into the securing sections 216 and 236, and the alignment sections 218 and 238 may have smooth inner surfaces. Additionally, the lips 214 and 234 may serve to guide the engagement devices into the securing sections 216 and 236, respectively.

The channel 232 of the third portion 230 of the securing member 202 may extend parallel to the channel 212 of the second portion 210 of the securing member 202, and the channel 282 of the third portion 280 of the mating member 250 may extend parallel to the channel 262 of the second portion 260 of the mating member 250. The channel 232 of the third portion 230 of the securing member 202 may extend parallel to the channel 282 of the third portion 280 of the mating member 250, and the channel 212 of the second portion 210 of the securing member 202 may extend parallel to the channel 262 of the second portion 260 of the mating member 250.

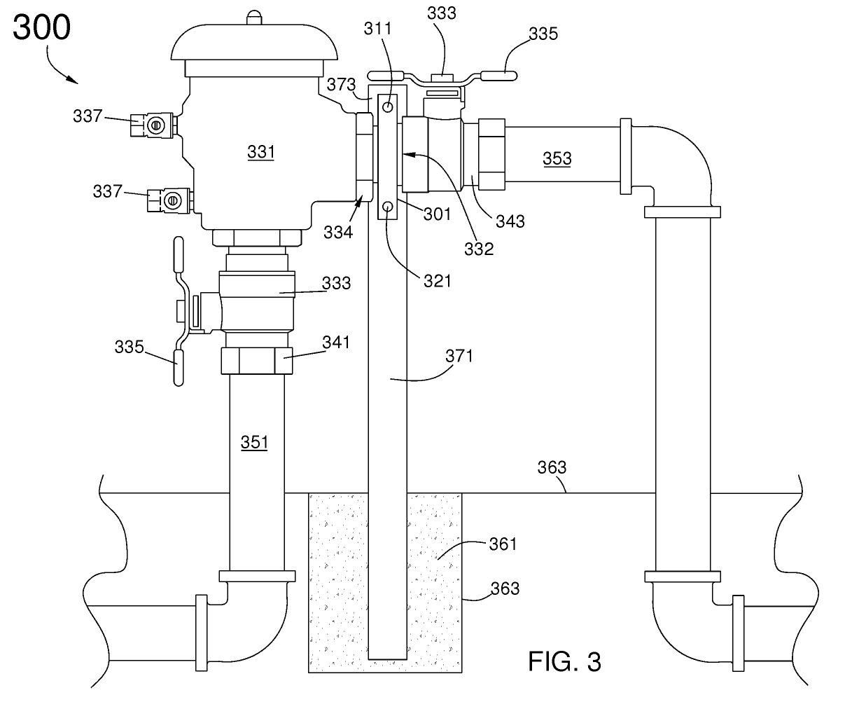

FIG. 3 shows an elevational view of an embodiment of the theft deterrent system 300 for a backflow preventer 331. Embodiments of the theft deterrent system 300 for a backflow preventer 331 may include the theft deterrent device 301, a first engagement device 311 (shown with dashed lines) positioned in the theft deterrent device 301, a second engagement device 321 (shown with dashed lines) positioned in the theft deterrent device 301, a post 371 connected to the theft deterrent device 301, and an anchor 361 fixed to the post 371.

The theft deterrent device 301 may be connected to the top 373 of the post 371. In FIG. 3, the anchor 361 is shown as cement in the ground 363, however, the anchor 361 may have other embodiments (such as welded configuration, bolted configuration, etc.) which also serve to fix the post 371 in the ground 363 and provide immobility of the post 371, and thus, the theft deterrent device 301 and backflow preventer 331. The post 371 may be made of a material that is not easily cut, such as metals, special polymers, or hybrid materials. In a theft situation, a thief must cut through the anchor 361, post 371 or the theft deterrent device 301 in order to remove the backflow preventer 331. The post 371 is made of a material and has a thickness which takes thieves a significant amount of time to cut, thus making theft of the backflow preventer 331 more dangerous, increasing the risk a thief is caught, and decreasing the number of thefts a thief is able to perform during a stealing spree.

Water flows from the public water supply in pipes 351, through the backflow preventer 331, and into a water system through pipes 353. The backflow preventer 331 includes valves 333 having handles 335, and petcocks 337. The theft deterrent device 301 fits around only a portion 332 of the backflow preventer 331, which has several advantages. First, the petcocks 337 of the backflow preventer 331 are used to test the backflow preventer 331 during inspections. In the inventive system 300, the theft deterrent device 301 may be positioned on a side 334 of the backflow preventer 331 opposite the petcocks 337. In this position the theft deterrent device 301 does not obstruct access to the petcocks and third-party inspectors do not have to coordinate with maintenance personnel in order to access the petcocks 337 for inspection of the backflow preventer 331. Thus, time is not wasted coordinating inspections of the backflow preventer 331 when the inventive theft deterrent device 301 is used in the inventive system 300. Second, the backflow preventer 331 may have two valves 333, and the theft deterrent device 301 may be positioned between the two valves 333 of the back flow preventer 331. The height of the theft deterrent device 301 clears the handle 335 of the valve 333, which may be easily turned between on and off positions while the theft deterrent device 301 is positioned on the portion 332 of the backflow preventer 301. The theft deterrent device 301 does not have to be removed in order turn any of the handles 335 of valves 333 between the on and off positions, and the valves 333 may be quickly turned on and off. Thus, no personnel coordination or access permission is needed to shut off valves 333 when backflow preventer 331 is compromised or fails. It is estimated thousands of gallons of water can be lost after a backflow preventer 331 is compromised or fails, and less water is lost in the event backflow preventer 331 is compromised or fails when the inventive theft deterrent device 301 and system 300 are used because access to the backflow preventer 331 is quick and without obstruction.

While the theft deterrent device 301 is shown in FIG. 3 as positioned around portion 332 of the backflow preventer 331, the theft deterrent device 301 may alternatively be positioned around a portion of the backflow preventer 301 below the petcocks 337 without affecting access to the petcocks by inspectors and without affecting changing any of the handles 335 of the valves 333 between the on and off positions. In this scenario, the theft deterrent device 301 is in a horizontal orientation (as opposed to the vertical orientation shown in FIG. 3), and the post 371 may be configured to connect to the theft deterrent device 301 in the horizontal orientation.

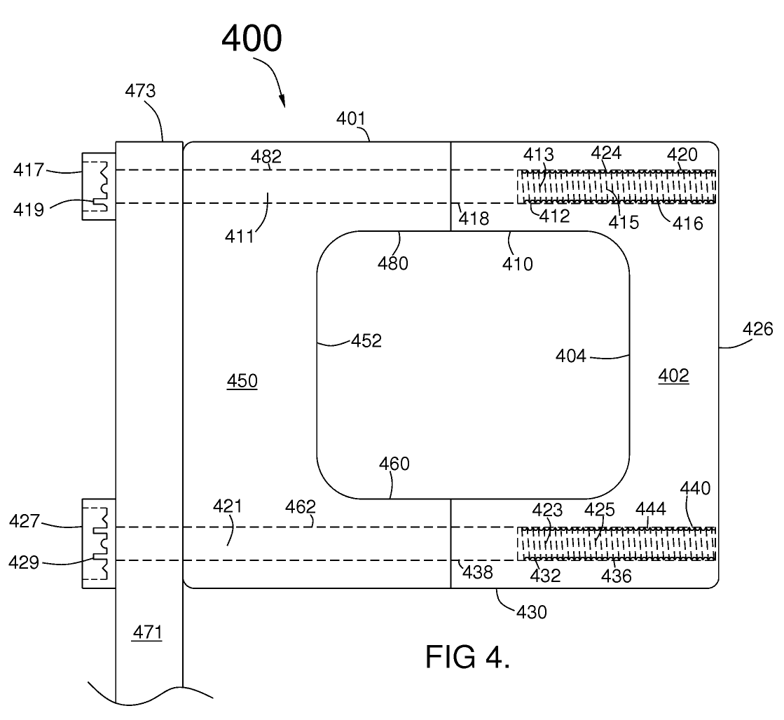

FIG. 4 shows an isolated elevational view of an embodiment of theft deterrent device 401, engagement devices 411 and 421, and post 471 of a theft deterrent system 400. Components of the inventive subject matter which extend within theft deterrent device 401, engagement devices 411 and 421, and post 471 are shown with dashed lines in FIG. 4.

A first engagement device 411 may be positioned through the channel 482 of the third portion 480 of the mating member 450 and in the channel 412 of the second portion 410 of the securing member 402, a second engagement device 421 may be positioned through the channel 462 of the second portion 460 of the mating member 450 and in the channel 432 of the third portion 430 of the securing member 402, and a post 471 may be connected to the mating member 450 of the theft deterrent device 401. The first engagement device 411 and the second engagement device 421 may pass through the post 471. The theft deterrent device 401 may be connected to the top 473 of the post 471.

The first engagement device 411 of the system 400 may have an engagement mechanism 413 positioned in the securing section 416 of the second portion 410 of the securing member 402, and the second engagement device 421 may have an engagement mechanism 423 positioned in the securing section 436 of the third portion 430 of the securing member 402. The engagement mechanisms 413 and 423 engage the securing sections 416 and 436, respectively, of the securing member 402 in a manner that deters thefts. In one or more embodiments, the engagement mechanisms 413 and 423 of the first and second engagement devices 411 and 421 may be threads 415 and 425, respectively. The threads 415 and 425 of the engagement devices 411 and 421 may engage with the threads 424 and 444 of the securing sections 416 and 436, respectively, of the securing member 402. The threads 424 and 444 may be formed on the inner surfaces 420 and 440 of the securing sections 416 and 436 of the channels 412 and 432, respectively, of the securing member 402. The engagement mechanisms 413 and 423 may further include LOCTITE™ adhesives to further engage and secure the engagement mechanisms 413 and 423 of the engagement devices 411 and 421 with the securing sections 416 and 436 of the securing member 402, respectively. Thus, the engagement mechanisms 413 and 423 may have two or more different engagement techniques which engage the engagement mechanisms 413 and 423.

In one or more embodiments, the first engagement device 411 and second engagement device 421 may have a security mechanism on ends thereof. The first engagement device 411 may have a security mechanism 417 on an end thereof, and the second engagement device 421 may have a security mechanism 427 on an end thereof.

In one or more embodiments of the inventive subject matter, the first engagement device 411 may be a theft deterrent bolt, and the second engagement device 421 may be a theft deterrent bolt. In FIG. 4, theft deterrent bolts are shown as the first and second engagement devices 411 and 421. The security mechanism 417 of the first engagement device 411 may be a head of a theft deterrent bolt having a uniquely contoured inner surface 419 (shown with dashed lines) which makes the first engagement device 411 non-rotatable unless a tool having a matching unique contour is used, thus making rotation of first engagement device 411 so as to remove the first engagement device 411 from the theft deterrent device 401 unlikely without the tool. The security mechanism 427 of the second engagement device 421 may be a head of a theft deterrent bolt having a uniquely contoured inner surface 429 (shown with dashed lines) which makes the second engagement device 421 non-rotatable unless a tool having a matching unique contour is used, thus making rotation of second engagement device 421 so as to remove the second engagement device 421 from the theft deterrent device 401 unlikely without the tool.

The system 400 of the inventive subject matter has many aspects of theft deterrence. First, the security mechanism 417 of the first engagement device 411 and the security mechanism 427 of the second engagement device 421 make rotation of the engagement devices 411 and 421 unlikely. Second, the engagement between the engagement mechanisms 413 and 423 and the securing sections 416 and 436, respectively, make removal of the engagement devices 411 and 421 time consuming. Third, the length, height, and thickness dimensions of the theft deterrent device 401 deter a thief from using cutting mechanisms to break the theft deterrent device 401. Fourth, the post 471 and anchor (reference numeral 361 in FIG. 3) make the theft deterrent device 401 (and the backflow preventer around which the theft deterrent device is positioned) immovable.

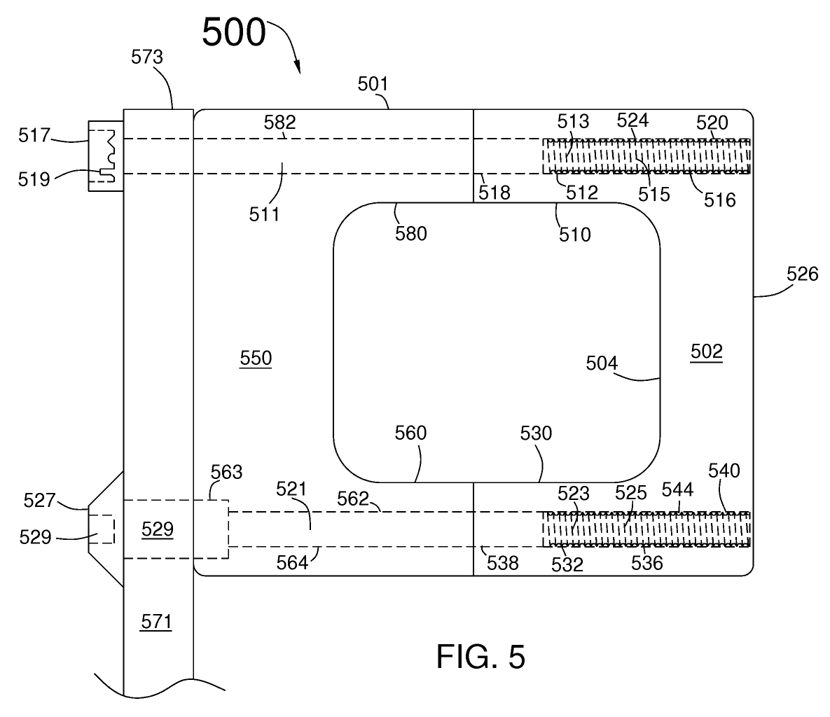

FIG. 5 shows an isolated elevational view of another embodiment of the theft deterrent device 501, engagement devices 521 and 511, and post 571 of a theft deterrent system 500. Components of the inventive subject matter which extend within theft deterrent device 501, engagement devices 511 and 512, and post 571 are shown with dashed lines in FIG. 5.

A first engagement device 511 may be positioned through the channel 582 of the third portion 580 of the mating member 550 and in the channel 512 of the second portion 510 of the securing member 502, a second engagement device 521 positioned through the channel 562 of the second portion 560 of the mating member 550 and in the channel 532 of the third portion 530 of the securing member 502, and a post 571 connected to the mating member 550 of the theft deterrent device 501. The first engagement device 511 and the second engagement device 521 may pass through the post 571. The theft deterrent device 501 may be connected to the top 573 of the post 571.

The first engagement device 511 of the system 500 may have an engagement mechanism 513 positioned in the securing section 516 of the second portion 510 of the securing member 502, and the second engagement device 521 may have an engagement mechanism 523 positioned in the securing section 536 of the third portion 530 of the securing member 502. The engagement mechanisms 513 and 523 engage the securing sections 516 and 536, respectively, of the securing member 502 in a manner that deters quick thefts. In one or more embodiments, the engagement mechanisms 513 and 523 of the first and second engagement devices 511 and 521 may be threads 515 and 524, respectively. The threads 515 and 525 of the engagement devices 511 and 521 may engage with the threads 524 and 544 of the securing sections 516 and 536, respectively, of the securing member 502. The threads 524 and 544 may be formed on the inner surfaces 520 and 540 of the securing sections 516 and 536 of the channels 512 and 532 of the securing member 502, respectively. The engagement mechanisms 513 and 523 may further include LOCTITE™ adhesives to further engage and secure the engagement mechanisms 513 and 523 of the engagement devices 511 and 521 with the securing sections 516 and 536 of the securing member 502, respectively.

In one or more embodiments, the first engagement device 511 and second engagement device 521 may have a security mechanism on ends thereof. The first engagement device 511 may have a security mechanism 517 on an end thereof, and the second engagement device 521 may have a security mechanism 527 on an end thereof.

In one or more embodiments of the inventive subject matter, the first engagement device 511 may be a theft deterrent bolt, and the second engagement device 521 may be a screw lock. In FIG. 5, a theft deterrent bolt is shown as the first engagement device 511, and a screw lock is shown as the second engagement device 521. The security mechanism 517 of the first engagement device 511 may a head of a theft deterrent bolt having a uniquely contoured inner surface 519 (shown with dashed lines) which makes the first engagement device 511 non-rotatable unless a tool having a matching unique contour is used, thus making rotation of first engagement device 511 so as to remove the first engagement device 511 from the theft deterrent device 501 unlikely. The security mechanism 527 of the second engagement device 521 may be a lock of a screw lock having a locking mechanism 529 (shown with dashed lines) which makes the second engagement device 521 non-rotatable unless a key is used, thus making rotation of second engagement device 521 so as to remove the second engagement device 521 from the theft deterrent device 501 unlikely.

In the embodiment of FIG. 5, channel 562 in mating member 550 may have a large portion 563 and small portion 564. The large portion 563 may have a diameter to accommodate the diameter of the locking mechanism 529 of the second engagement device 521. The large portion 563 may generally have a diameter larger than a diameter of the small portion 564.

The system 500 of the inventive subject matter has many aspects of theft deterrence. First, the security mechanism 517 of the first engagement device 511 may make rotation of the engagement device 511 unlikely without a unique tool matching the contoured surface 519. Second, the security mechanism 527 of the second engagement device 521 may make rotation of the second engagement device 511 unlikely without a key for the locking mechanism 529. Third, the engagement between the engagement mechanisms 513 and 523 and the securing sections 516 and 536, respectively, may make removal of the engagement devices 511 and 521 time consuming. Fourth, the length, height, and thickness dimensions of the theft deterrent device 501 may deter a thief from using cutting mechanisms to break the theft deterrent device 501. Fifth, the post 571 and anchor (reference numeral 361 in FIG. 3) may make the theft deterrent device 501 (and the backflow preventer around which the theft deterrent device is positioned) immovable.

It should be understood first engagement device 511 in embodiments of the inventive subject matter may be a theft deterrent bolt, a screw lock, or another type of lock, and second engagement device 521 in embodiments of the inventive subject matter may be a theft deter bolt, a screw lock, or another type of lock.

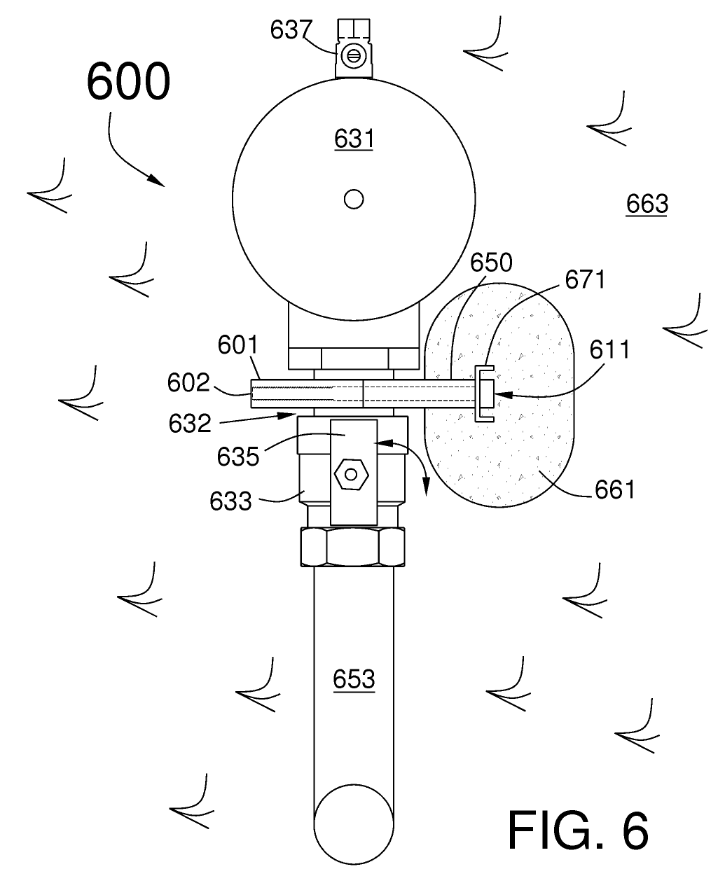

FIG. 6 shows a plan view of an embodiment of the theft deterrent system 600. The backflow preventer 631 may have petcocks extending from a side thereof. A valve 633 of the backflow preventer 631 may be positioned on a side of the backflow preventer 631 opposite the petcocks 637. Water flows through the backflow preventer 631 and into a water system through pipes 653. The theft deterrent device 601 of the system 600 may be seen connected to the post 671, and the post 671 may be seen fixed to anchor 671. In the embodiment shown in FIG. 6, the anchor 671 may be cement in the ground 663. The mating member 650 and the securing member 602 of the theft deterrent device 601 may be positioned around a portion 632 of the backflow preventer 631 adjacent valve 633. Engagement device 611 passes through the post 671 and into the theft deterrent device 601. The engagement device 611 passes through the mating member 650 and engages in the securing member 602 of the theft deterrent device 601. Handle 635 of valve 633 may move between the on and off positions along the path shown by the double-ended arrow. The post 671 shown in FIG. 6 may have a U-shaped cross-section.

The rectangular shape of the opening in the theft deterrent device 601 formed by the concavities unexpectedly provides more flexibility than a circular shape for the orientation of the theft deterrent device 601 relative to the backflow preventer 631. Installations of the system 600 may not always be perfect. During installation of the inventive system 600, the post 671 may possibly extend at an angle different than perpendicular from the anchor 661, which may cause the theft deterrent device 601 connected to the post 671 to angle upwardly or downwardly relative to the backflow preventer 631. Even though the configuration of backflow preventers is generally tubular, the rectangular shape of the opening in the theft deterrent device 601 formed by the concavities unexpectedly accounts for imperfect installations better than a circular opening and allows more flexibility during installation of the theft deterrent device 601 on a backflow preventer 631 without sacrificing the theft deterrent qualities of the inventive subject matter.

Embodiments of a method for deterring theft of a backflow preventer may include positioning the theft deterrent device around the backflow preventer, inserting a first engagement device into the theft deterrent device, inserting a second engagement device into the theft deterrent device, engaging an engagement mechanism of the first engagement device with the securing section of the second portion of the securing member of the theft deterrent device, engaging an engagement mechanism of the second engagement device with the securing section of the third portion of the securing member of the theft deterrent device, positioning a post adjacent the theft deterrent device, inserting the first engagement device through the post, inserting the second engagement device through the post, and anchoring the post.

The method may also include connecting the post to the theft deterrent device, engaging at least two engagement mechanisms of the first engagement device, engaging at least two engagement mechanisms of the second engagement device. The step of inserting the first engagement device may include rotating a theft deterrent bolt, and the step of inserting the second engagement device may include rotating a theft deterrent bolt or rotating a screw lock. The step of inserting the first engagement device may include threading the first engagement device into a securing section of the securing member for at least about 2″, and the step of inserting the second engagement device may include threading the second engagement device into another securing section of the securing member for at least about 2″.

The method may further include unlocking the first engagement device and the second engagement device from the theft deterrent device. Unlocking the first and second engagement devices may include matching a unique contour tool with the head of a theft deterrent bolt and rotating the theft deterrent bolt so as to remove the theft deterrent bolt from the theft deterrent device. Unlocking the second engagement device may alternatively include inserting a key into a screw lock, activating the locking mechanism, and rotating the screw lock so as to remove the screw lock from the theft deterrent device.

It is estimated the cost of installing the theft deterrent device and system of the inventive subject matter may be about one hundred dollars. Thus, cost savings of installing the theft deterrent device and system of the inventive subject matter is an extremely large percentage. Water systems having many backflow preventers may save on the order of thousands if not tens of thousands of dollars by installing the theft deterrent device and system of the inventive subject matter.

The above description is illustrative and explanatory of embodiments of the disclosed inventive subject matter. Various changes and modifications may be made to the embodiments within the scope of the disclosed inventive subject matter. The disclosed inventive subject matter therefore should be limited only by the following claims and their legal equivalents.

We claim:

1. A securing member for a theft deterrent device for a backflow preventer, the securing member comprising:
a first portion;
a second portion extending from an end of the first portion; and
a third portion extending from an opposite end of the first portion, wherein the second portion of the securing member has a channel extending therein, wherein the third portion of the securing member has a channel extending therein, wherein the channel of the second portion and the channel of the third portion each have a securing section therein.

2. A theft deterrent device for a backflow preventer comprising:
the securing member of claim 1; and
a mating member comprising:
a first portion;
a second portion extending from an end of the first portion of the mating member; and
a third portion extending from an opposite end of the first portion of the mating member, wherein the second portion of the mating member has a channel extending therethrough, wherein the third portion of the mating member has a channel extending therethrough, wherein the channel of the second portion of the mating member is aligned with the channel of the third portion of the securing member, wherein the channel of the third portion of the mating member is aligned with the channel of the second portion of the securing member.

3. The theft deterrent device of claim 2, wherein the mating member has a length greater than a length of the securing member, wherein the mating member has a height equal to a height of the securing member.

4. The theft deterrent device of claim 2, wherein the third portion of the mating member has a length equal to a length of the second portion of the mating member, wherein the third portion of the securing member has a length equal to a length of the second portion of the securing member.

5. The theft deterrent device of claim 1, wherein the securing section of the channel of the second portion of the securing member and the securing section of the channel of the third portion of the securing member each have threads formed on an inner surface thereof.

6. The theft deterrent device of claim 1, wherein the channel of the second portion of the securing member and the channel of the third portion of the securing member each have an alignment section, wherein the securing section has a length substantially greater than a length of the alignment section.

7. The theft deterrent device of claim 2, wherein the mating member and the securing member each have a concavity, wherein the concavity of the mating member faces the concavity of the securing member.

8. The theft deterrent device of claim 7, wherein the concavity of the mating member and the concavity of the securing member form a substantially rectangular shape.

9. The theft deterrent device of claim 1, wherein the channel of the second portion of the securing member and the channel of the third portion of the securing member each open to a side of the securing member.

10. The theft deterrent device of claim 2, wherein the channel of the second portion of the mating member and the channel of the third portion of the mating member each open to a side of the mating member, wherein the channel of the second portion of the mating member and the channel of the third portion of the mating member each open to an opposite side of the mating member.

11. A theft deterrent system for a backflow preventer comprising:
the theft deterrent device of claim 2;
a first engagement device positioned through the channel of the third portion of the mating member and in the channel of the second portion of the securing member, wherein the first engagement device has an engagement mechanism positioned in the securing section of the second portion of the securing member; and
a second engagement device positioned through the channel of the second portion of the mating member and in the channel of the third portion of the securing member, wherein the second engagement device has an engagement mechanism positioned in the securing section of the third portion of the securing member.

12. The system of claim 11, wherein the mating member and the securing member of the theft deterrent device fit around a portion of the backflow preventer.

13. The system of claim 12, wherein the first engagement member has a security mechanism on an end thereof, wherein the second engagement member has a security mechanism on an end thereof.

14. The system of claim 12, wherein the backflow preventer has two valves, wherein the theft deterrent device is positioned between the two valves.

15. The system further comprising:
a post connected to the mating member of the theft deterrent device, the first engagement device and the second engagement device passing through the post; and
an anchor fixed to the post.

16. The system of claim 11, wherein the first engagement device comprises a theft-deterrent bolt, wherein the second engagement device comprises a theft-deterrent bolt.

17. The system of claim 11, wherein the engagement mechanism of the first engagement device comprises threads.

18. The system of claim 17, wherein the engagement mechanism of the second engagement device comprises a lock.

19. A method for deterring theft of a backflow preventer, the method comprising:
positioning the theft deterrent device of claim 2 around the backflow preventer;
inserting a first engagement device into the theft deterrent device;
inserting a second engagement device into the theft deterrent device;
engaging an engagement mechanism of the first engagement device with the securing section of the second portion of the securing member of the theft deterrent device; and
engaging an engagement mechanism of the second engagement device with the securing section of the third portion of the securing member of the theft deterrent device.

20. The method of claim 19, further comprising:
positioning a post adjacent the theft deterrent device;
inserting the first engagement device through the post;
inserting the second engagement device through the post; and
anchoring the post.
